(19) United States
(12) Patent Application Publication
(10) Pub. No.: US 2015/0242115 A1
(43) Pub. Date: Aug. 27, 2015

(54) SYSTEMS AND METHODS FOR IMPROVED SIGNAL TO NOISE RATIO IN TOUCH SYSTEMS

(71) Applicant: QUALCOMM Incorporated, San Diego, CA (US)

(72) Inventors: Qiang Gao, San Diego, CA (US); William Yee-Ming Huang, Vista, CA (US); Hsun Wei David Wong, San Diego, CA (US); Teresa Ka Ki Ng, San Diego, CA (US); Rex Wang, San Diego, CA (US); Carol King Mui Law, San Diego, CA (US); Suhail Jalil, Poway, CA (US)

(21) Appl. No.: 14/621,029

(22) Filed: Feb. 12, 2015

Related U.S. Application Data
(60) Provisional application No. 61/943,235, filed on Feb. 21, 2014.

(51) Int. Cl. G06F 3/0488; G06F 3/041

(52) U.S. Cl. CPC G06F 3/04883; G06F 3/0416; G06F 2203/04808

(57) ABSTRACT

Systems, methods, and devices for filtering touch input data are contained herein. In one aspect, a method of filtering a touch input received on a touch interface is disclosed. The method includes receiving a first touch input at a first time, receiving a second touch input at a second time, determining a touch velocity based on the first and second touch inputs, adjusting filtering parameters based on the determined velocity, and filtering the second touch input based on the adjusted filtering parameters.

### RELATED APPLICATIONS

This application claims the benefit of U.S. Provisional Patent Application No. 61/943,235, filed Feb. 21, 2014, titled “SYSTEMS AND METHODS FOR IMPROVED SIGNAL TO NOISE RATIO IN TOUCH SYSTEMS,” the disclosure of which is hereby incorporated herein by reference in its entirety and for all purposes.

### BACKGROUND

1. Technical Field

The present application relates generally to touch devices, and more specifically to systems, methods, and devices for improving the signal to noise ration of touch systems.

2. Description of the Related Art

Advances in technology have resulted in smaller and more powerful computing devices. For example, there currently exist a variety of portable computing devices, including wireless computing devices such as wireless telephones, personal digital assistants (PDAs), and tablet computers that are small, lightweight, and easily carried by users. In order to simplify user interfaces and to avoid pushbuttons and complex menu systems, such portable computing devices may use touch screen displays that detect user gestures on the touch screen and translate the detected gestures into commands to be performed by the device. Such gestures may be performed using one or more fingers or a stylus type pointing implement.

Implementing multi-touch technology on portable computing devices typically requires processing overhead for recognizing multi-touch. Processing overhead measures the total amount of work the central processing unit (CPU) of the device can perform and the percentage of that total capacity which is used by individual computing tasks, such as touch detection. In total, these tasks must require less than the processor's overall capacity. Simple touch gestures may typically be handled by a touchscreen controller, which is a separate processor associated with the touch screen, but more complex touch gestures require the use of a secondary processor, often the mobile device's CPU, to process large amounts of touch data. Typically, large amounts of touch data must be processed to determine the nature of the touch, sometimes only to conclude that a touch was a “false positive,” consuming large amounts of CPU capacity and device power. The processing overhead required for complex touch recognition may require a large percentage of the overall CPU capacity, impairing device performance.

Existing mobile processors are not well adapted to deal with increasing touch complexity and corresponding CPU overhead, especially in conjunction with the many other common high performance uses of mobile devices. Increasing the size of the mobile processor core or cache delivers performance increases only up to a certain level, beyond which heat dissipation issues make any further increase in core and cache size impractical. Overall processing capacity is further limited by the smaller size of many mobile devices, which limits the number of processors that can be included in the device. Additionally, because mobile computing devices are generally battery-powered, high performance uses also shortens battery life.

Despite mobile processing limitations, many common mobile applications such as maps, games, email clients, web browsers, etc., are making increasingly complex use of touch recognition. Further, touch processing complexity increases proportional to touch-node capacity, which in turn increases proportional to display size. Therefore, because there is a trend in many portable computing devices toward increasing display size and touch complexity, touch processing is increasingly threatening battery life. Further, user interaction with a device through touch events is highly sensitive to latency, and user experience can suffer from low throughput interfaces between the touchscreen panel and the host processor resulting in processing delay and response lag.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below.

Embodiments and innovations described herein relate to systems and methods that may be run in a processor for an electronic device to improve the signal to noise ratio of a touch input using adaptive filtering. Preferably, adaptive filtering methods have a wide range of controls and can be implemented in existing hardware or software. However, in some embodiments, specially designed hardware and software may improve speed or efficiencies of such processes.

One innovation of the disclosure provides a method of filtering a touch input. The method includes receiving a first touch input at a first time, receive a second touch input at a second time, determine a touch velocity based on the first and second touch inputs, adjust filtering parameters based on the determined velocity; and filter the second touch input based on the adjusted filtering parameters. In some aspects, adjusting filtering parameters comprises adjusting a weight of the filter. In some aspects, filtering the second touch input comprises temporally filtering the second touch input. In some aspects, the method includes aligning the first touch input and the second touch input before filtering the second touch input. In some aspects, the method includes determining an amplitude change in a data point included in the second touch input resulting from the filtering of the second touch input; and adjusting a touch detection threshold based on the amplitude change. In some aspects, the method includes first determining if a first data point included in the first touch input exceeds a first threshold, second determining a ratio of the first data point to a corresponding second data point included in the second touch input; and filtering the second data point using the first data point based on the first and second determining.

In some innovations, the second touch input is not filtered using the first data point if the first data point exceeds the first threshold and the ratio is greater than a second threshold. In some aspects, the method includes determining whether or not to filter a plurality of data points in the second touch input with respective data points in the first touch input based on whether their respective data points in the first touch input exceed the first threshold and a ratio of each data point in the plurality of data points in the second touch input to the data point's respective data point in the first touch input.

Another innovation disclosed is an apparatus for filtering a touch input. The apparatus includes a processor, a touch device; and a memory, operably coupled to the processor, and configured to store processor instructions that configure the processor to: receive a first touch input at a first time, receive a second touch input at a second time, determine a touch velocity based on the first and second touch inputs, adjust filtering parameters based on the determined velocity, and filter the second touch input based on the adjusted filtering parameters.

In some innovations, adjusting filtering parameters comprises adjusting a weight of the filter. In some aspects, filtering the second touch input comprises temporally filtering the second touch input. In some aspects, the memory stores instructions that configure the processor to align the first touch input and the second touch input before filtering the second touch input. In some aspects, the memory stores instructions that further configure the processor to: determine an amplitude change of a data point included in the second touch input resulting from the filtering, and adjust a touch detection threshold based on the amplitude change. In some aspects, the memory stores instructions that further configure the processor to: first determine if a first data point included in the first touch input exceeds a first threshold, second determine a ratio of the first data point to a corresponding second data point included in the second touch input, and determine whether to filter the second data point using the first data point based on the first and second determining. In some aspects, the memory stores instructions that further configure the processor to not filter the second data point using the first data point if the first data point exceeds the first threshold and the ratio is greater than a second threshold. In some aspects, the memory stores instructions that further configure the processor to determine whether or not to filter a plurality of data points in the second touch input with respective data points in the first touch input based on whether their respective data points in the first touch input exceed the first threshold and a ratio of each data point in the plurality of data points in the second touch input to the data point's respective data point in the first touch input.

In one innovation, a method of filtering a touch input is disclosed. The method includes receiving a first touch input at a first time; receiving a second touch input at a second time; determining a touch velocity based on the first and second touch inputs; adjusting filtering parameters based on the determined velocity; and filtering the second touch input based on the adjusted filtering parameters. In some embodiments, adjusting filtering parameters comprises adjusting a weight of a filter. In some embodiments, filtering the second touch input comprises temporally filtering the second touch input. In some embodiments, the method further includes aligning the first touch input and the second touch input before filtering the second touch input. In some embodiments, the method further includes determining a difference in amplitude between a data point included in the second touch input and a corresponding data point in the filtered second touch input; and adjusting a touch detection threshold based on the difference in amplitude. In some embodiments, the method further includes first determining if a first data point included in the first touch input exceeds a first threshold; second determining a ratio of the first data point at a touch node to a second data point at the same touch node of the second touch input; and filtering the second data point using the first data point based on the first and second determining. In some embodiments, the second touch input is not filtered using the first data point if the first data point exceeds the first threshold and the ratio is greater than a second threshold. In some embodiments, the method further includes determining whether or not to filter a plurality of data points in the second touch input with respective data points in the first touch input based on whether the respective data points in the first touch input exceed the first threshold and a ratio of each data point in the plurality of data points in the second touch input to the data point's respective data point in the first touch input exceeds the second threshold.

In another innovation, an apparatus for filtering a touch input includes a processor; a touch device; and a memory, operably coupled to the processor, and configured to store processor instructions that configure the processor to receive a first touch input at a first time; receive a second touch input at a second time; determine a touch velocity based on the first and second touch inputs; adjust filtering parameters based on the determined velocity; and filter the second touch input based on the adjusted filtering parameters. In some embodiments, adjusting filtering parameters comprises adjusting a weight of a filter. In some embodiments, filtering the second touch input comprises temporally filtering the second touch input. In some embodiments, the memory stores instructions that configure the processor to align the first touch input and the second touch input before filtering the second touch input. In some embodiments, the memory stores instructions that further configure the processor to determine a difference in amplitude between a data point included in the second touch input and a corresponding data point in the filtered second touch input, and adjust a touch detection threshold based on the difference in amplitude. In some embodiments, the memory stores instructions that further configure the processor to first determine if a first data point included in the first touch input exceeds a first threshold; second determine a ratio of the first data point at a touch node to a second data point at the same touch node of the second touch input; and filter the second data point using the first data point based on the first and second determining. In some embodiments, the memory stores instructions that further configure the processor to not filter the second data point using the first data point if the first data point exceeds the first threshold and the ratio is greater than a second threshold. In some embodiments, the memory stores instructions that further configure the processor to determine whether or not to filter a plurality of data points in the second touch input with respective data points in the first touch input based on whether the respective data points in the first touch input exceed the first threshold and a ratio of each data point in the plurality of data points in the second touch input to the data point's respective data point in the first touch input exceed a second threshold.

In yet another innovation, a system for filtering a touch input includes a control module configured to receive a first touch input at a first time; receive a second touch input at a second time; determine a touch velocity based on the first and second touch inputs; adjust filtering parameters based on the determined velocity; and filter the second touch input based on the adjusted filtering parameters. In some embodiments, the system further includes a touch interface. In some embodiments, the control module is a component of a touch interface application for a mobile device. In some embodiments, the control module is further configured to align the first touch input and the second touch input before filtering the second touch input. In some embodiments, the control module is further configured to determine a difference in amplitude between a data point in the second touch input and a corresponding data point in the filtered second touch input; and adjust a touch detection threshold based on the difference in amplitude. In some embodiments, the control module is further configured to first determine if a first data point included in the first touch input exceeds a first threshold; second determine a ratio of the first data point at a touch node to a second data point at the same touch node of the second touch input; and determine whether to filter the second data point using the first data point based on the first and second determining. In some embodiments, the control module is further configured to not filter the second data point using the first data point if the first data point exceeds the first threshold and the ratio is greater than a second threshold. In some embodiments, the control module is further configured to determine whether or not to filter a plurality of data points in the second touch input with respective data points in the first touch input based on whether the respective data points in the first touch input exceed the first threshold and a ratio of each data point in the plurality of data points in the second touch input to the data point's respective data point in the first touch input exceeds a second threshold.

In another innovation, a non-transitory computer-readable medium storing instructions that, when executed, cause at least one physical computer processor to perform method of filtering touch input data, the method including receiving a first touch input at a first time; receiving a second touch input at a second time; determining a touch velocity based on the first and second touch inputs; adjusting filtering parameters based on the determined velocity; and filtering the second touch input based on the adjusted filtering parameters. In some embodiments, adjusting filtering parameters comprises adjusting a weight of a filter. In some embodiments, the method further includes aligning the first touch input and the second touch input before filtering the second touch input; determining a difference in amplitude between a data point in the second touch input and a corresponding data point in the filtered second touch input; and adjusting a touch detection threshold based on the difference in amplitude. In some embodiments, the method further includes first determining if a first data point included in the first touch input exceeds a first threshold; second determining a ratio of the first data point at a touch node to a second data point at the same touch node of the second touch input; and filtering the second data point using the first data point based on the first and second determining. In some embodiments, the second touch input is not filtered using the first data point if the first data point exceeds the first threshold and the ratio is greater than a second threshold. In some embodiments, the method further includes determining whether or not to filter a plurality of data points in the second touch input with respective data points in the first touch input based on whether the respective data points in the first touch input exceed the first threshold and a ratio of each data point in the plurality of data points in the second touch input to the data point's respective data point in the first touch input exceeds the second threshold.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A illustrates a functional block diagram of a wireless device that may be employed within a wireless communication system.

FIG. 1B illustrates a functional block diagram of a mobile computing device equipped with touch processing.

FIG. 2 illustrates a graph showing the combination of two consecutive touch signals that may be used to suppress noise and produce an improved combined signal, according to one embodiment.

FIG. 3 illustrates increased lag associated with a combined signal when a touch input is moving over time.

FIG. 4 illustrates a reduced signal amplitude of a combined signal.

FIG. 5 illustrates an artifact spike in touch signals that may result when a touch input moves relatively fast across a touch screen.

FIG. 6 illustrates alignment of a first signal with a second signal before temporal filtering.

FIGS. 7A-B illustrate the result of processing a thin stylus linear swipe without adaptive filtering (FIG. 7A) and with adaptive filtering (FIG. 7B).

FIG. 8 is a flowchart of a method of adapting the filtering of touch input based on a velocity of the touch input.

### DETAILED DESCRIPTION

Signal noise in touch systems reduces the touch position accuracy and touch swipe linearity of a touch signal. To improve the signal to noise ratio of the touch signal, temporal adaptive filtering may be applied to consecutive touch data frames. A touch frame captures all of the touch sensor values at about the same time. Specifically, touch signals from stylus input are particularly noisy as generally the stylus is made of plastic and the touch signals of stylus input are generally much weaker than finger-input signals (approximately 1/10 of finger-input signals). To improve the signal to noise ratios of the touch signal, signals from the same sensor node at different times may be combined to produce a clearer signal.

It is noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Embodiments may be implemented in System-on-Chip (SoC) or external hardware, software, firmware, or any combination thereof. Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

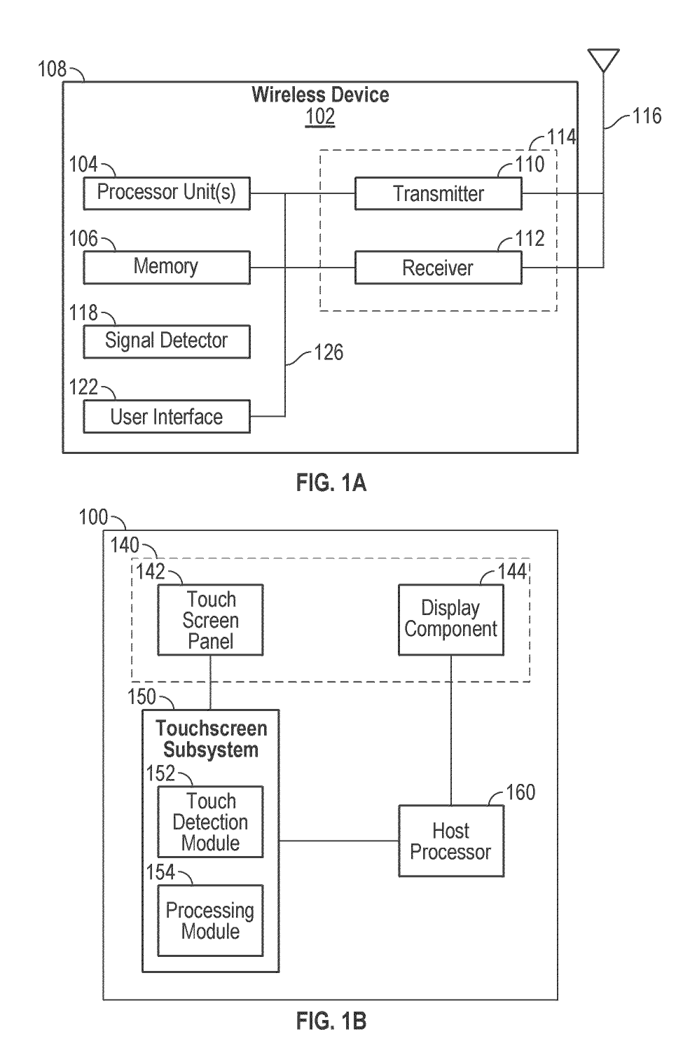

FIG. 1A illustrates various components that may be utilized in a wireless device 102 that may be employed within a wireless communication system. The wireless device 102 is an example of a device that may be configured to implement the various methods for improving the signal to noise ratio of the touch signal described herein.

The wireless device 102 may include a processor 104 which controls operation of the wireless device 102. The processor 104 may also be referred to as a central processing unit (CPU). Memory 106, which may include both read-only memory (ROM) and random access memory (RAM), may provide instructions and data to the processor 104. A portion of the memory 106 may also include non-volatile random access memory (NVRAM). The processor 104 typically performs logical and arithmetic operations based on program instructions stored within the memory 106. The instructions in the memory 106 may be executable to implement the methods described herein.

The processor 104 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 102 may also include a housing 108. The transmitter 110 and/or a receiver 112 may be disposed in the housing 108, and are configured to transmit and receive data, so wireless device 102 can communicate with another communication device at a remote location. The transmitter 110 and receiver 112 may be combined into a transceiver 114. An antenna 116 may be attached to the housing 108 and electrically coupled to the transceiver 114. The wireless device 102 may also include (not shown) multiple transmitters, multiple receivers, multiple transceivers, and/or multiple antennas.

The transmitter 110 may be configured to wirelessly transmit packets having different packet types or functions. For example, the transmitter 110 may be configured to transmit packets of different types generated by the processor 104. When the wireless device 102 is implemented or used as an access point or station, the processor 104 may be configured to process packets of a plurality of different packet types. For example, the processor 104 may be configured to determine the type of packet and to process the packet and/or fields of the packet accordingly.

The receiver 112 may be configured to wirelessly receive packets having different packet types. In some aspects, the receiver 112 may be configured to detect a type of a packet used and to process the packet accordingly.

The wireless device 102 may also include a signal detector 118 that may be used in an effort to detect and quantify the level of signals received by the transceiver 114. The signal detector 118 may detect such signals as total energy, energy per subcarrier per symbol, power spectral density and other signals. The wireless device 102 may also include a digital signal processor (DSP) for use in processing signals. The DSP may be configured to generate a packet for transmission. In some aspects, the packet may comprise a physical layer data unit (PPDU).

The wireless device 102 may further comprise a user interface 122 in some aspects. The user interface 122 may comprise a keypad, a microphone, a speaker, and/or a display, including a touch display in some aspects. The user interface 122 may include any element or component that conveys information to a user of the wireless device 102 and/or receives input from the user. Systems and methods for improving the signal to noise ratio of the touch signal can be implemented in a mobile device such as device 102 having a user interface 122 comprising a touch display.

The various components of the wireless device 102 may be coupled together by a bus system 126. The bus system 126 may include a data bus, for example, as well as a power bus, a control signal bus, and a status signal bus in addition to the data bus. The components of the wireless device 102 may be coupled together or accept or provide inputs to each other using some other mechanism.

Although a number of separate components are illustrated in FIG. 1A, one or more of the components may be combined or commonly implemented. For example, the processor 104 may be used to implement not only the functionality described above with respect to the processor 104, but also to implement the functionality described above with respect to the signal detector 118 and/or the DSP. Further, each of the components illustrated in FIG. 1A may be implemented using a plurality of separate elements.

FIG. 1B illustrates a block diagram of a mobile computing device 100 in accordance with one embodiment of the present disclosure. The device 100 comprises a display 140, a touch screen subsystem 150, and a host processor 160. The illustrated embodiment is not meant to be limiting and device 100 may include a variety of other components as required for other functions.

The display 140 of device 100 may include a touch screen panel 142 and a display component 144. Certain embodiments of display component 144 may be any flat panel display technology, such as an LED, LCD, plasma, or projection screen. Display component 144 may be coupled to the host processor 160 for receiving information for visual display to a user. Such information includes, but is not limited to, visual representations of files stored in a memory of device 100, software applications installed on device 100, user interfaces, and network-accessible content objects.

Touch screen panel 142 may employ one or a combination of many touch sensing technologies, for instance capacitive, resistive, surface acoustic wave, or optical touch sensing. In some embodiments, touch screen panel 142 may overlay or be positioned over display component 144 such that visibility of the display component 144 is not impaired. In other embodiments, the touch screen panel 142 and display component 144 may be integrated into a single panel or surface. The touch screen panel 142 may be configured to cooperate with display component 144 such that a user touch on the touch screen panel 142 is associated with a portion of the content displayed on display component 144 corresponding to the location of the touch on touch screen panel 142. Display component may also be configured to respond to a user touch on the touch screen panel 142 by displaying, for a limited time, a visual representation of the touch.

Touch screen panel 142 may be coupled to a touch screen subsystem 150, the touch screen subsystem 150 comprising a touch detection module 152 and a processing module 154. The touch screen panel 142 may cooperate with touch screen subsystem 150 to enable device 100 to sense the location, pressure, direction and/or shape of a user touch or touches on display 140. The touch detection module 152 may include instructions that when executed can scan the area of the touch screen panel 142 for touch events and to provide the coordinates of touch events to the processing module 154. In some embodiments, the touch detection module 152 may be an analog touch screen front end module comprising a plurality of software drivers.

The processing module 154 of the touch screen subsystem 150 may be configured to analyze touch events and to communicate touch data to host processor 160. The processing module 154 may, in some embodiments, include instructions that when executed act as a touch screen controller (TSC). The specific type of TSC employed will depend upon the type of touch technology used in panel 142. The processing module 154 may be configured to start up when the touch detection module 152 indicates that a user has touched touch screen panel 142 and to power down after release of the touch. This feature may be useful for power conservation in battery-powered devices such as mobile computing device 100.

Processing module 154 may be configured to perform filtering on touch event data received from touch detection module. For example, in a display 140 where the touch screen panel 142 is placed on top of a display component 144 comprising and LCD screen, the LCD screen may contribute noise to the coordinate position measurement of the touch event. In some implementations, this noise may be a combination of impulse noise and Gaussian noise. The processing module 154 may be configured with median and averaging filters to reduce this noise. Instead of using only a single sample for the coordinate measurement of the touch event, the processing module 154 may be programmed to instruct the touch detection module 152 to provide two, four, eight, or 16 samples. These samples may then be sorted, median filtered, and averaged to give a lower noise, more accurate result of the touch coordinates.

The processing module 154 is a processor specifically configured for use with the touch screen subsystem 150, while host processor 160 may be configured to handle the general processing requirements of device 100. The processing module 154 and the host processor 160 may be in communication with each other. In some embodiments, the mobile computing device 100 may include some or all of the elements of the wireless device 102 shown in FIG. 1A, such as a transceiver 114 and an antenna 116.

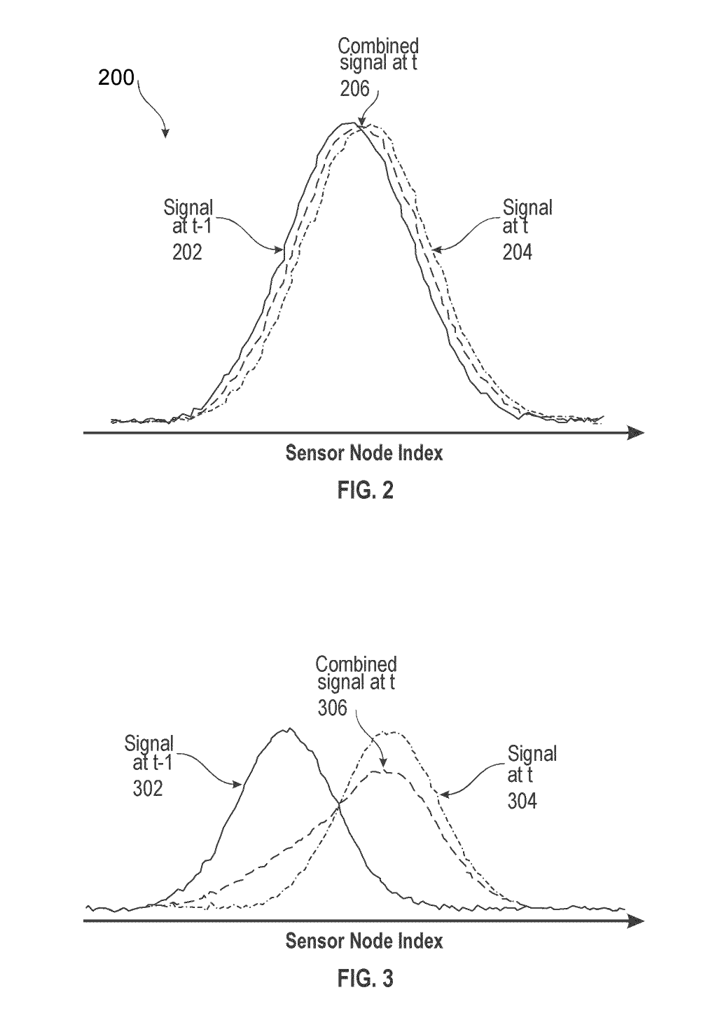

As discussed above, fast moving touches or swipes may be more susceptible to increased lag or missed touches. FIG. 2 illustrates a graph 200 illustrating an example of an embodiment where two consecutive touch signals are used to determine a resulting touch signal. For example, where two consecutive touch signals are combined to suppress noise and produce an improved combined signal, according to some embodiments. Noise in touch systems reduces the touch position accuracy and touch swipe linearity. The disclosed methods and systems may apply temporal filtering on consecutive touch data frames to filter out noises and improve the touch signal-to-noise-ratio (SNR). As discussed in greater detail below, the signal at a touch sensor node at position (x, y) at time t−1 may be represented as s(x, y, t−1), shown in FIG. 2 as curve 202. The signal at a touch sensor node at position (x, y) at time t may be represented as s(x, y, t), shown in FIG. 2 as curve 204. In FIG. 2, curve 206 is the resulting output signal (for example, a filtered output signal) that combines the signal at t−1 (curve 202) and the signal at t (curve 204) to suppress the noise. The curve 206 is smoother and has higher SNR due to suppressed noise.

Filtering by combining the two signals 202, 204 generally works well when the touch does not move or moves slowly. A simple temporal filtering solution presents additional challenges when the touch is moving. To solve these challenges, the disclosed methods and systems may adapt the signal filters in one or more aspects. For example, the filter parameters may be adapted based on the speed of movement of the touch signal. For example, a touch signal that moves rapidly across a screen may have a smaller amplitude than a touch signal moving more slowly. Therefore, touch detection thresholds may be adapted based on the speed of the touch signals movement across the screen. Other filter parameters may also be adapted based on the speed of the touch movement. Additionally, sequential touch signals may be aligned before being filtered. This may improve the results of filtering performed on the touch signals.

FIG. 3 shows increased lag associated with a combined signal 306 formed by combining a signal at t−1 (curve 302) with a signal at t (curve 304) when a touch input is moving. The left side of the combined signal 306 produced by temporal filtering the input signals is larger (or has a shallower slope) than the right side of the combined signal 306. This may result in a centroid estimation of the touch event that is biased toward the left side of the signal and lags behind the true touch location. This observable lag in the centroid position can result in frustration for the user due to inaccuracies in the estimated centroid position of the touch event if the combined signal is used with no further processing or filtering.

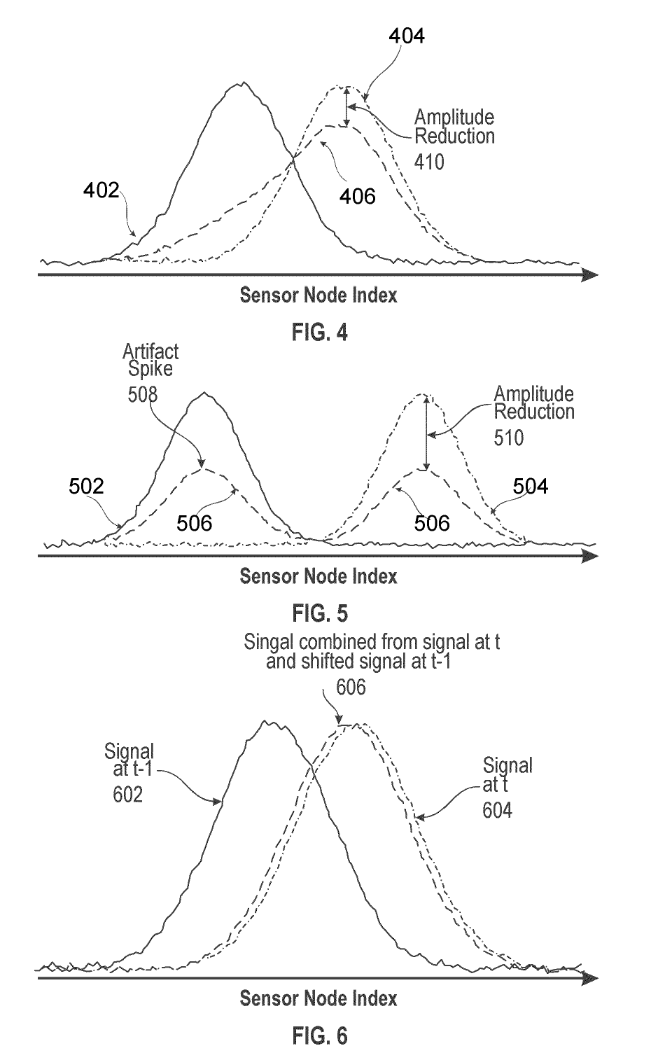

FIG. 4 illustrates reduced signal amplitude of a combined signal 406. The combined signal 406 is a result of the combination of the signal at t−1 (curve 402) and the signal at t (curve 404). As shown, the combined signal 406 has a peak that is reduced in amplitude from the input signal 404 by an amplitude reduction 410. In addition to the lag associated with the combined signal 406 which may affect the estimation of the centroid position, the reduced signal amplitude may result in missed touch events.

FIG. 5 shows an artifact spike 508 in a combined touch signal 506 that may result when a touch input moves relatively fast across a touch screen. The combined signal 506 may be produced by combining the signal 502 with the signal 504. Because the peaks of the two input signals 502, 504 are spread across the sensor node index, the combined signal 506 may incorporate a reduced amplitude spike 508, shown on the left side of the graph, associated with each of the input signals 502, 504. This artifact spike 508 may result in a false touch event being detected.

The disclosed methods and systems provide more accurate touch position estimation and improved linearity with signal from a relatively inexpensive analog front end (AFE), as inexpensive AFEs generally have relatively more noise. The disclosed methods and systems may also be applied to AFEs running at lower voltage to save power (lower voltage means lower SNR).

To provide for a more accurate touch estimation without the lags or missed touch events described above, temporal filter and system parameters may be adapted based on the touch moving velocity and other factors, for example.

In some embodiments, the signal at the touch sensor node at position (x,y) at time t is denoted as:

s(x,y,t) Eqn. 1

The temporal filter output for the signal at the touch sensor node at (x,y) at time t is denoted as:

u(x,y,t) Eqn. 2

Eqn. 2 may be calculated by the following formula:

u(x,y,t)=w*s(x,y,t)+F(s(x,y,t−1),s(x,y,t−2), . . . ) Eqn. 3

The temporal filter output combines the signals from the same touch sensor node at different times. Note that the weight w controls how much the signal at time t, s(x,y,t), will contribute to the filter output.

For example, in one embodiment, a weight w for an exponentially weighted moving average (EWMA) filter may be used when determining the combined signal. EWMA is a type of infinite impulse response filter that applies weighting factors that decrease exponentially. The weighting for each older datum decreases exponentially, never reaching zero. The EWMA filter places more importance to more recent data by discounting older data in an exponential manner.

When the EWMA filter is applied, Eqn. 3 becomes:

u(x,y,t)=w*s(x,y,t)+w(1−w)s(x,y,t−1)+w(1−w)²s(x,y,t−2)+ . . . Eqn. 4

FIG. 6 shows a first signal 602 at time t−1, a second signal 604 at time t and a combined signal 606 combined from the signal at t and a shifted signal at t−1. FIG. 6 illustrates alignment of a first signal 602 with a second signal 604 before temporal filtering. When the two signals 602 and 604 are “aligned” in FIG. 6, the touch signal at time t−1 (signal 602) is shifted such that the touch spike of signal 602 at time t−1 is aligned with the touch spike of signal 604 at time t.

With the signals aligned as described above, the temporal filtering formula becomes:

u(x,y,t)=w*s(x,y,t)+F(s(x−c₁,y−d₁,t−1)s(x−c₂,y−d₂,t−2), . . . ) Eqn. 5

Note that the alignment is achieved by the position shift c1, d1, c2, d2, etc. (that is, the alignment is done in such way that the peaks of the touch spikes at different times are aligned). The alignment combines the signals from different touch sensor nodes at different times. In some embodiments, the touch spike alignment is performed prior to temporal filtering.

To manage the reduced amplitude of the combined signal 506 as shown in FIG. 5, several adjustments to the temporal filtering may be made. For example, a larger weight may be applied to the current signal, such as the t signal (curve 604) as described above to adapt for a faster moving touch signal. This will mitigate the effects of the increased lag of the combined signal 406 and the amplitude reduction of the combined signal 506. Two sequential signals may also be aligned as described above with respect to FIG. 6 before the temporal filtering is performed. In some aspects, the touch detection threshold may be adapted based on a signal amplitude change. In some aspects, an unfiltered signal may be used to determine a preliminary touch event.

To reduce detection of false touch events, adjustments to the temporal filtering may be made. For example, alignment of sequential signals before temporal filtering may be performed as described above with respect to FIG. 6. Additionally, the artifact spike (such as the artifact spike 508 shown in FIG. 5) may be detected via signal processing and then eliminated from the signals either before or after temporal filtering is performed. For example, in some aspects, a signal at a touch node at position (x,y) at time t−1, s(x,y,t−1), may be discounted or ignored if s(x,y,t−1) exceeds a certain threshold, and the ratio of s(x,y,t−1) to a signal at the same touch node at t, s(x,y,t) exceeds a second threshold. Note that only signals at some touch nodes are ignored. For example, the decision of whether or not to filter data points in a second touch input with respective data points in a first touch input may be based on whether the data points of the first touch input exceed a certain threshold and a ratio of the data points of the second touch input to the respective data point in the first touch input exceed a second threshold.

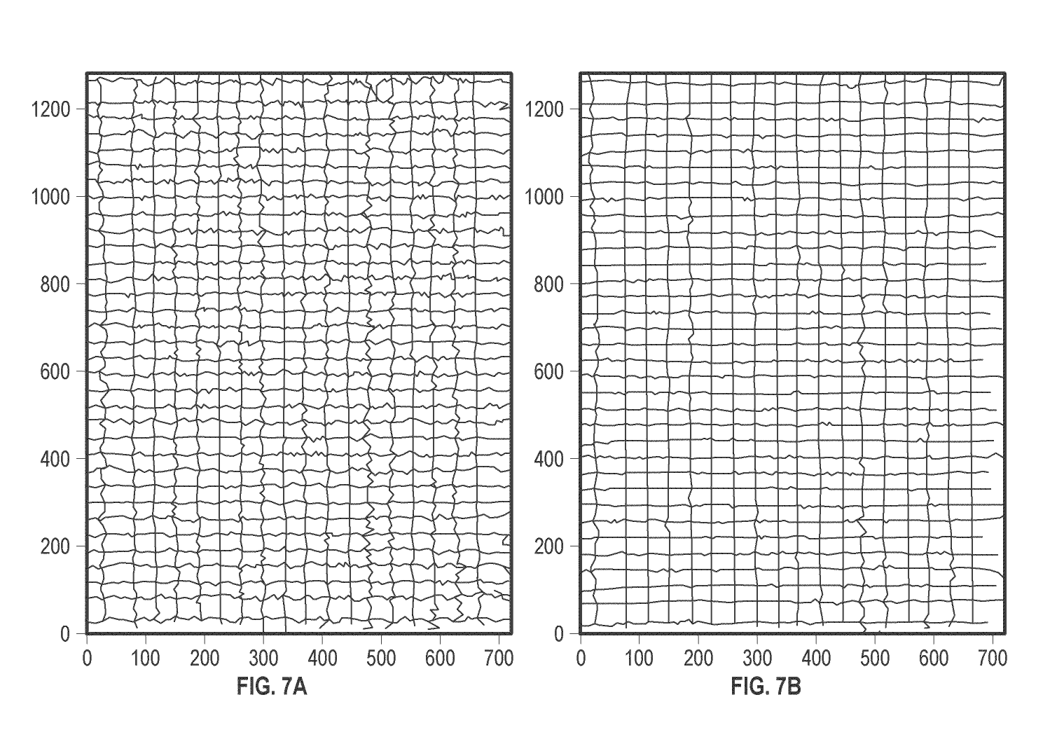

Both left to right and up to down thin linear stylus swipes across the entire touch node index of the touch screen are illustrated in FIGS. 7A and 7B. Touch signals from stylus input are particularly noisy because, for example, the stylus is made of plastic and the touch signals of stylus input are generally much weaker than finger-input signals due to differences in the way a touchscreen senses a finger and a stylus. FIGS. 7A and 7B illustrate the result of processing a thin stylus linear swipe without filtering (FIG. 7A) and with filtering (FIG. 7B). As illustrated, the lines in FIG. 7A, representing signal inputs of stylus swipes in the horizontal and vertical direction (with respect to the screen orientation) are more jagged and uneven across the entire node index of the touch screen than the lines in FIG. 7B. The unfiltered results illustrated in FIG. 7A indicate that the linear stylus sweeps are jagged and uneven prior to filtering. This unevenness could lead to incorrect estimation of the location of a touch event. In this example, the disclosed adaptations of filtering may reduce the linear fit Mean Square Error (MSE) by approximately 45% (for example, 23.7 to 12.8), resulting in a linear stylus swipe processing that is more smooth and even as shown in FIG. 7B.

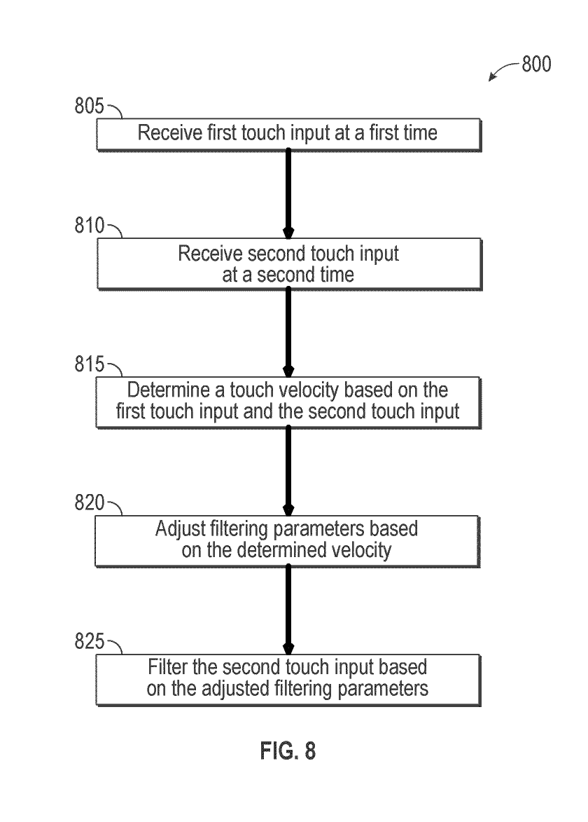

FIG. 8 is a flowchart of a method of adapting the filtering of touch input based on a velocity of the touch input. In some aspects, the process 800 may be performed by the wireless device 102 of FIG. 1A or the device 100 of FIG. 1B or incorporated in other hardware or software.

In block 805, a first touch input is received at a first time. For example, the first touch input may be the data represented by the signal 302 at t−1 in FIG. 3 in some aspects. In block 810, a second touch input is received at a second time. In some aspects, the second touch input may be the data represented by the signal 304 at time t in FIG. 3.

In block 815, a touch velocity is determined based on the first and second touch inputs. In block 820, filtering parameters are adjusted based on the determined velocity. For example, in some aspects, as discussed above, a weight for an exponential weighted moving average (EWMA) filter may be adjusted based on the determined velocity. In some aspects, as velocity increases, a weight w for a EWMA filter may be increased and the current signal will contribute more to the filter output.

In block 825, the second touch input is filtered based on the adjusted filtering parameters. In some aspects, the second touch input is filtered using temporal filtering based on the first touch input and the adjusted filtering parameters.

In some aspects of the process 800, a touch threshold may be adjusted based on an amplitude change resulting from the filtering. For example, amplitudes of data points within a touch input above the touch threshold may be indicative of a touch event. When the touch input is moving faster across the screen, the amplitudes of the data points within the touch signal may be reduced relative to a slower moving touch input. This may be caused by the temporal filtering. Therefore, the touch threshold may be adjusted to compensate for the lower amplitudes associated with higher touch velocities. Touch events may then be detected based on the adjusted touch threshold(s).

In some aspects, an unfiltered touch signal may be utilized to make a preliminary touch detection determination based on the determined touch velocity.

Some aspects of the process 800 also include aligning the first touch data with the second touch data as shown above with respect to FIG. 6. As discussed above, aligning the touch signals prior to filtering can improve filtering results. Adaptive filtering, as illustrated by the method shown in FIG. 8, can reduce lag and improve touch detection. Touch detection thresholds may be adapted based on the speed of the touch signals movement across the screen. Other filter parameters may also be adapted based on the speed of the touch movement. Additionally, sequential touch signals may be aligned before being filtered.

### CLARIFICATIONS REGARDING TERMINOLOGY

The word “exemplary” is used herein to mean “serving as an example, instance, or illustration.” Any embodiment described herein as “exemplary” is not necessarily to be construed as preferred or advantageous over other embodiments. Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

It should be understood that any reference to an element herein using a designation such as “first,” “second,” and so forth does not generally limit the quantity or order of those elements. Rather, these designations may be used herein as a convenient wireless device of distinguishing between two or more elements or instances of an element. Thus, a reference to first and second elements does not mean that only two elements may be employed there or that the first element must precede the second element in some manner. Also, unless stated otherwise a set of elements may include one or more elements.

A person/one having ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

A person/one having ordinary skill in the art would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with the figures may be implemented within or performed by an integrated circuit (IC), an access terminal, or an access point. The IC may include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, and circuits may include antennas and/or transceivers to communicate with various components within the network or within the device. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The functionality of the modules may be implemented in some other manner as taught herein. The functionality described herein (e.g., with regard to one or more of the accompanying figures) may correspond in some aspects to similarly designated “means for” functionality in the appended claims.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of filtering a touch input, comprising:
receiving a first touch input at a first time;
receiving a second touch input at a second time;
determining a touch velocity based on the first and second touch inputs;
adjusting filtering parameters based on the determined velocity; and
filtering the second touch input based on the adjusted filtering parameters.

2. The method of claim 1, wherein adjusting filtering parameters comprises adjusting a weight of a filter.

3. The method of claim 2, wherein filtering the second touch input comprises temporally filtering the second touch input.

4. The method of claim 3, further comprising aligning the first touch input and the second touch input before filtering the second touch input.

5. The method of claim 1, further comprising:
determining a difference in amplitude between a data point in the second touch input and a corresponding data point in the filtered second touch input; and
adjusting a touch detection threshold based on the difference in amplitude.

6. The method of claim 1, further comprising:
first determining if a first data point included in the first touch input exceeds a first threshold;
second determining a ratio of the first data point at a touch node to a second data point at the same touch node of the second touch input; and
filtering the second data point using the first data point based on the first and second determining.

7. The method of claim 6, wherein the second touch input is not filtered using the first data point if the first data point exceeds the first threshold and the ratio is greater than a second threshold.

8. The method of claim 7, further comprising determining whether or not to filter a plurality of data points in the second touch input with respective data points in the first touch input based on whether the respective data points in the first touch input exceed the first threshold and a ratio of each data point in the plurality of data points in the second touch input to the data point's respective data point in the first touch input exceeds the second threshold.

9. An apparatus for filtering a touch input, comprising:
a processor;
a touch device; and
a memory, operably coupled to the processor, and configured to store processor instructions that configure the processor to
receive a first touch input at a first time;
receive a second touch input at a second time;
determine a touch velocity based on the first and second touch inputs;
adjust filtering parameters based on the determined velocity; and
filter the second touch input based on the adjusted filtering parameters.

10. The apparatus of claim 9, wherein adjusting filtering parameters comprises adjusting a weight of a filter.

11. The apparatus of claim 10, wherein filtering the second touch input comprises temporally filtering the second touch input.

12. The apparatus of claim 11, wherein the memory stores instructions that configure the processor to align the first touch input and the second touch input before filtering the second touch input.

13. The apparatus of claim 9, wherein the memory stores instructions that further configure the processor to:
determine a difference in amplitude between a data point in the second touch input and a corresponding data point in the filtered second touch input; and
adjust a touch detection threshold based on the difference in amplitude.

14. The apparatus of claim 9, wherein the memory stores instructions that further configure the processor to:
first determine if a first data point included in the first touch input exceeds a first threshold;
second determine a ratio of the first data point at a touch node to a second data point at the same touch node of the second touch input; and
filter the second data point using the first data point based on the first and second determining.

15. The apparatus of claim 14, wherein the memory stores instructions that further configure the processor to not filter the second data point using the first data point if the first data point exceeds the first threshold and the ratio is greater than a second threshold.

16. The apparatus of claim 15, wherein the memory stores instructions that further configure the processor to determine whether or not to filter a plurality of data points in the second touch input with respective data points in the first touch input based on whether the respective data points in the first touch input exceed the first threshold and a ratio of each data point in the plurality of data points in the second touch input to the data point's respective data point in the first touch input exceed a second threshold.

17. A system for filtering a touch input, comprising:
a control module configured to
receive a first touch input at a first time;
receive a second touch input at a second time;
determine a touch velocity based on the first and second touch inputs;
adjust filtering parameters based on the determined velocity; and
filter the second touch input based on the adjusted filtering parameters.

18. The system of claim 17, further comprising a touch interface.

19. The system of claim 18, wherein the control module is a component of a touch interface application for a mobile device.

20. The system of claim 19, wherein the control module is further configured to align the first touch input and the second touch input before filtering the second touch input.

21. The system of claim 17, wherein the control module is further configured to:
determine a difference in amplitude between a data point in the second touch input and a corresponding data point in the filtered second touch input; and
adjust a touch detection threshold based on the difference in amplitude.

22. The system of claim 17, wherein the control module is further configured to:
first determine if a first data point included in the first touch input exceeds a first threshold;
second determine a ratio of the first data point at a touch node to a second data point at the same touch node of the second touch input; and
filter the second data point using the first data point based on the first and second determining.

23. The system of claim 22, wherein the control module is further configured to not filter the second data point using the first data point if the first data point exceeds the first threshold and the ratio is greater than a second threshold.

24. The system of claim 22, wherein the control module is further configured to determine whether or not to filter a plurality of data points in the second touch input with respective data points in the first touch input based on whether the respective data points in the first touch input exceed the first threshold and a ratio of each data point in the plurality of data points in the second touch input to the data point's respective data point in the first touch input exceeds a second threshold.

25. A non-transitory computer-readable medium storing instructions that, when executed, cause at least one physical computer processor to perform method of filtering touch input data, the method comprising:
receiving a first touch input at a first time;
receiving a second touch input at a second time;
determining a touch velocity based on the first and second touch inputs;
adjusting filtering parameters based on the determined velocity; and
filtering the second touch input based on the adjusted filtering parameters.

26. The non-transitory computer-readable medium of claim 25, wherein adjusting filtering parameters comprises adjusting a weight of a filter.

27. The non-transitory computer-readable medium of claim 26, further comprising:
aligning the first touch input and the second touch input before filtering the second touch input;
determining a difference in amplitude between a data point in the second touch input and a corresponding data point in the filtered second touch input; and
adjusting a touch detection threshold based on the difference in amplitude.

28. The non-transitory computer-readable medium of claim 27, further comprising:
first determining if a first data point included in the first touch input exceeds a first threshold;
second determining a ratio of the first data point at a touch node to a second data point at the same touch node of the second touch input; and
filtering the second data point using the first data point based on the first and second determining.

29. The non-transitory computer-readable medium of claim 28, wherein the second touch input is not filtered using the first data point if the first data point exceeds the first threshold and the ratio is greater than a second threshold.

30. The non-transitory computer-readable medium of claim 29, further comprising determining whether or not to filter a plurality of data points in the second touch input with respective data points in the first touch input based on whether the respective data points in the first touch input exceed the first threshold and a ratio of each data point in the plurality of data points in the second touch input to the data point's respective data point in the first touch input exceeds the second threshold.
